(19) United States
(12) Patent Application Publication
(10) Pub. No.: US 2026/0153271 A1
(43) Pub. Date: Jun. 4, 2026

(54) CURVED TROUGH SOLAR CONCENTRATOR

(71) Applicant: Idealab Studio, LLC, Pasadena, CA (US)

(72) Inventors: William Tod Gross, Pasadena, CA (US); Andrea Pedretti, Thousand Oaks, CA (US)

(21) Appl. No.: 19/177,414

(22) Filed: Apr. 11, 2025

Related U.S. Application Data
(60) Provisional application No. 63/633,997, filed on Apr. 15, 2024.

(51) Int. Cl. F24S 20/20; F24S 10/70; F24S 23/70

(52) U.S. Cl. CPC F24S 20/20; F24S 10/70; F24S 23/82; F24S 2023/834; F24S 2023/872

(57) ABSTRACT

A solar power concentrator system includes a housing and a glass coupled to the housing to define an enclosure therebetween. A trough concentrator is rotatably disposed in the enclosure. The trough concentrator includes a pair of end plates, a tube or pipe extending along the length of the support frame that allows a fluid to pass therethrough, a support frame extending between and attached to the end plates, and a reflective film having opposite edges attached to side rails of the support frame. The reflective film has a curved (e.g., parabolic) shape between the opposite edges and can reflect sunlight onto the tube or pipe. An actuator rotates the trough concentrator about an axis of the end plates to vary an orientation of the reflective film. The glass shields the reflective film of the trough concentrator from wind.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present disclosure is directed to a solar power concentrator system, and more particularly to a solar power concentrator system with one or more curved trough solar concentrators.

### Description of the Related Art

Existing solar concentrators are costly to manufacture and can have complex structures for tracking the sun.

### SUMMARY

Accordingly, there is a need for an improved solar concentrator that is inexpensive to manufacture and simple in construction.

In accordance with one aspect of the disclosure, a parabolic trough concentrator is provided that uses a reflective film as the reflective surface and a frame that supports and couples to the reflective film in a simple manner. The reflective film is held at opposite edges, the portion of the sheet between the edges allowed to hang and naturally form a parabolic shape. In another example, the reflective film sits on ribs of a support structure of the parabolic trough concentrator. In another example, the reflective film forms a non-parabolic shape. The reflective film can be rotated or pivoted about an axis (via the frame) to track the sun. The concentrator includes a glass enclosure spaced over the reflective film that protects the reflective film from wind forces (as well as dust and debris), thereby reducing the amount of power needed to actuate the rotation of the frame to adjust an orientation of the reflective film relative to the sun.

In some aspects, the techniques described herein relate to a parabolic solar power concentrator system, including: a housing; a glass coupled to the housing to define an enclosure therebetween; a parabolic trough concentrator rotatably disposed in the enclosure, including a pair of end plates, a support frame extending between and attached to the end plates, a tube or pipe extending along a length of the support frame configured to allow a fluid to pass therethrough, a reflective film having opposite edges attached to side rails of the support frame, the reflective film having a parabolic shape between the opposite edges and configured to reflect sunlight onto the tube or pipe, and an actuator coupled to one of the end plates and operable to rotate the parabolic trough concentrator about an axis of the end plates to vary an orientation of the reflective film, wherein the glass shields the parabolic trough concentrator from wind.

In some aspects, the techniques described herein relate to a solar power concentrator system, including: a housing; a glass coupled to the housing to define an enclosure therebetween; a trough concentrator rotatably disposed in the enclosure, including a pair of end plates, a support frame extending between opposite ends of the housing and attached to the end plates, a tube or pipe extending along a length of the support frame configured to allow a fluid to pass therethrough,, the tube or pipe extending along an axis between the opposite ends of the housing a reflective film having opposite edges attached to side rails of the support frame, the reflective film having a parabolic curved shape between the opposite edges and configured to reflect sunlight onto the tube or pipe, and an actuator coupled to one of the end plates and operable to rotate the trough concentrator about the axis to vary an orientation of the reflective film, wherein the glass shields the reflective file of the trough concentrator from wind.

In some aspects, the techniques described herein relate to a solar power concentrator system, including: a housing; a glass coupled to the housing to define an enclosure therebetween; a trough concentrator rotatably disposed in the enclosure, including a support frame extending between opposite ends of the housing, a tube or pipe extending along a length of the support frame configured to allow a fluid to pass therethrough, the tube or pipe extending along an axis between the opposite ends of the housing, a reflective film having opposite edges attached to side rails of the support frame, the reflective film having a parabolic curved shape between the opposite edges and configured to reflect sunlight onto the tube or pipe, and an actuator operable to rotate the trough concentrator about the axis to vary an orientation of the reflective film, wherein the glass shields the reflective film of the trough concentrator from wind.

In some aspects, the techniques described herein relate to a solar power concentrator system, including: a housing; a glass coupled to the housing to define an enclosure therebetween; a trough concentrator rotatably disposed in the enclosure, including a support frame extending between opposite ends of the housing, a tube or pipe extending along a length of the support frame configured to allow a fluid to pass therethrough, the tube or pipe extending along an axis between the opposite ends of the housing a reflective film having opposite edges attached to side rails of the support frame, the reflective film having a curved shape between the opposite edges and configured to reflect sunlight onto the tube or pipe, and an actuator operable to rotate the trough concentrator about the axis to vary an orientation of the reflective film, wherein the glass shields the reflective film of the trough concentrator from wind.

### BRIEF DESCRIPTION OF THE DRAWINGS

FIG. 1 is a schematic perspective view of a trough concentrator system.

FIG. 2 is another schematic perspective view of the trough concentrator system of FIG. 1.

FIG. 3 is another schematic perspective view of the trough concentrator system of FIG. 1.

FIG. 4 is another schematic perspective view of the trough concentrator system of FIG. 1, with a portion of the outer housing removed.

FIG. 5 is a schematic partial side view of the trough concentrator system of FIG. 1, with a portion of the outer housing and glass enclosure removed.

FIG. 6 is a schematic top view of the trough concentrator system of FIG. 1.

FIG. 7 is a schematic cross-sectional view of the trough concentrator system across a width of the unit of FIG. 1.

FIG. 8 is a schematic exploded view of the trough concentrator system of FIG. 1.

FIG. 9 is a schematic exploded view of a trough concentrator of the trough concentrator system of FIG. 1.

FIG. 10 is a schematic side view of the trough concentrator of FIG. 9.

FIG. 11 is a schematic perspective view of a trough concentrator assembly.

FIG. 12 is a schematic end view of a reflective film in a non-parabolic shape.

### DETAILED DESCRIPTION

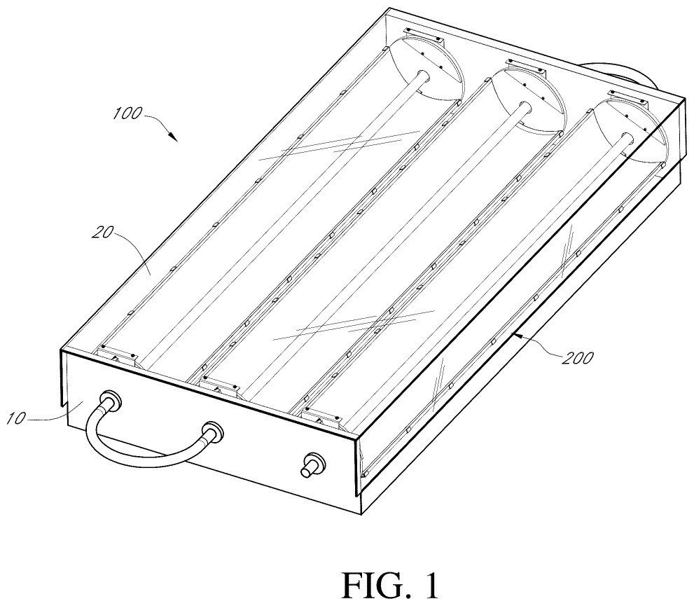

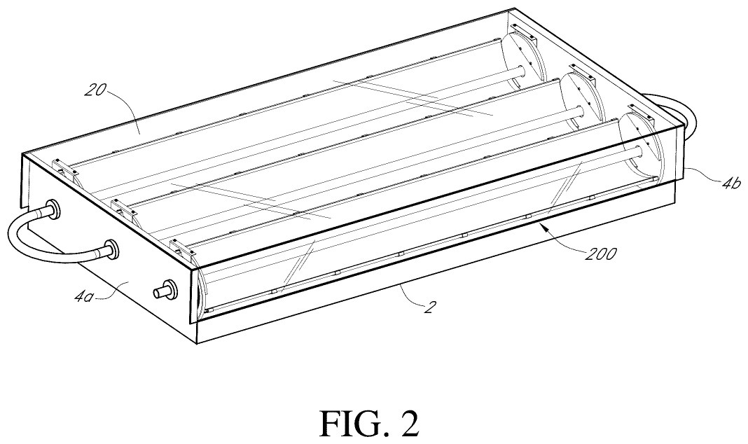

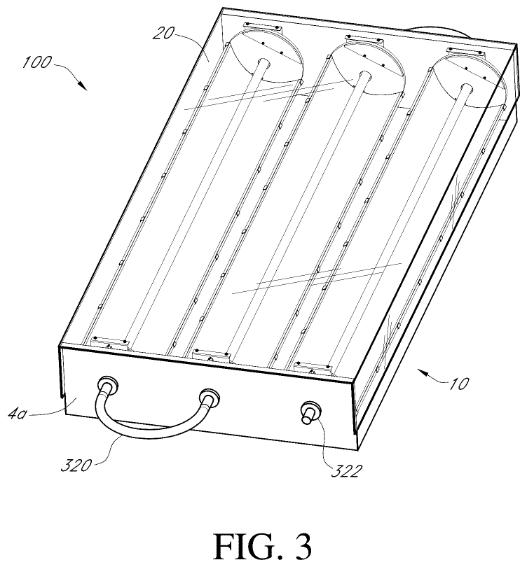

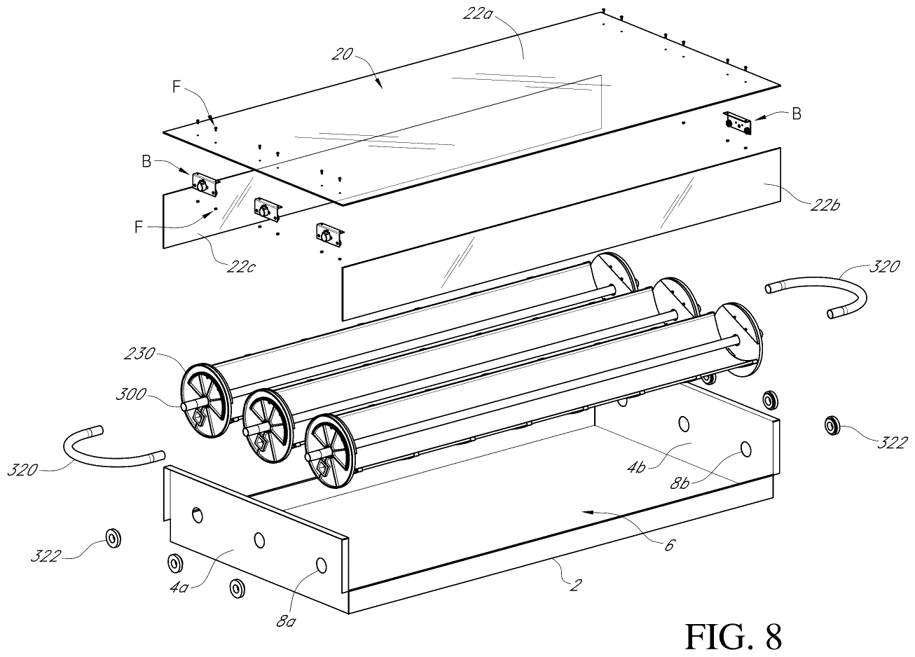

FIGS. 1-8 show a trough concentrator system 100 (hereafter also referred to as “the concentrator system 100”). The concentrator system 100 has three trough concentrators 200. However, the concentrator system 100 can have any number (e.g. one, two, four, five, etc.) of trough concentrators 200. The concentrator system 100 can be affixed to the ground or other rigid surface.

The concentrator system 100 has a housing 10 with a base 2 that extends along a length L between opposite walls 4a, 4b that define a channel 6 therebetween. One or more openings 8a (e.g., circular openings) on one wall 4a align with corresponding openings 8b on the opposite wall 4b. The trough concentrator(s) 200 are rotatably coupled to the opposite walls 4a, 4b via the openings 8a, 8b and disposed in the channel 6. The concentrator system 100 has a glass 20 that attaches to the top of the walls 4a, 4b so that the glass 20 is spaced above the trough concentrator(s) 200. In one example, the glass 20 has a top surface 22a and opposite side surfaces 22b, 22c so that the glass 20 extends over the top and the sides of the walls 4a, 4b, such that the trough concentrator(s) 200 are enclosed between the glass 20 and the housing 10 (e.g., in an enclosure defined by and between the housing 10 and glass 20).

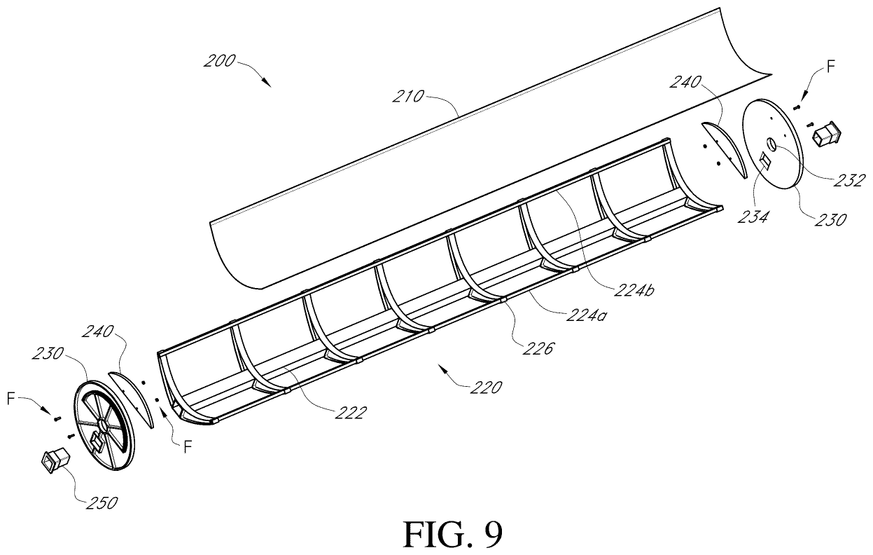

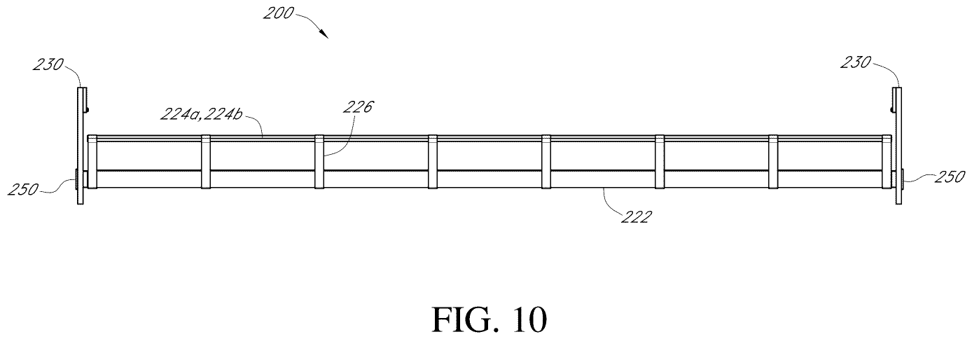

FIGS. 9-10 show a trough concentrator 200, which includes a reflective film 210, a support frame 220, a pair of end plates (e.g. circular end plates) 230, a pair of plates (e.g., semicircular plates) 240, a pair of connectors 250 (e.g., male connectors). The pair of plates 240 are counterweights (e.g., made of steel) that can be attached to the pair of end plates 230 to match the center of gravity for the trough concentrator 200. The pair of end plates (e.g., circular end plates) 230 have a center opening 232 (along an axis of rotation of the end plates 230) and a second opening 234 radially offset from the center opening 232. In one example, the center opening 232 is circular. In one example, the second opening 234 is square. The reflective film 210 can be flexible (with no inherent structural rigidity) and extend along a same length as the support frame 220. In one example, the reflective film 210 can be a mylar film, for example aluminized mylar. The reflective film 210 can be a sheet or film of reflective plastic. In one example, the reflective film 210 can have a thickness of approximately 1 mil.

The support frame 220 can have a center beam 222, a pair of side rails 224a, 224b that extend on opposite sides of the center beam 222, and one or more (e.g., multiple, a plurality of) cross-beams 226 attached to the center beam 222 and the side rails 224a, 224b. In one example, the support frame 220 has multiple (e.g., eight) spaced apart cross-beams 226. In one example, the center beam 222 has a square shaped cross-section (e.g., hollow square cross-section). In one example, the side rails 224a, 224b have a square shaped cross-section (e.g., hollow square cross-section). The cross-beam(s) 226 can have slots 227 on opposite ends of the cross-beam(s) 226 that are sized to receive and couple (e.g., removably couple) to the side rails 224a, 224b. For example, where the side rails 224a, 224b have a square cross-section, the slots 227 can have a square C-shape, allowing the side rails 224a, 224b to be inserted into (and retained in) the slots 227 to couple the side rails 224a, 224b to the cross-beam(s) 226. The cross-beam(s) 226 can have a curved surface 228 (e.g., a parabolic curvature) that extends between the slots 227. The pair of end plates 230 couple to opposite ends of the support frame 220 via the pair of connectors 250, which can be inserted in the second openings 234 of the pair of end plates 230 and into ends of the center beam 222. Advantageously, the center openings 232 can coincide with the center of gravity of the end plates 230, making the end plates 230, and thereby the trough concentrator(s) 200 easier to rotate with actuators, as discussed further below.

The reflective film 210 can be attached (e.g., with an adhesive) along opposite edges thereof to the side rails 224a, 224b (to a top surface of the side rails 224a, 224b), and can be coupled to the cross-beam(s) 226 via the slots 227 (e.g., by inserting a bottom portion of the side rails 224a, 224b into the slots 227). In one example, the reflective film 210 is supported by (e.g., in contact with) the curved surface 228 of the cross-beam(s) 226, via which the reflective film 210 attains its shape (e.g., parabolic curvature). In another example, the reflective film 210 is spaced from the curved surface 228 of the cross-beam(s) 226 so that it is only supported by the side rails 224a, 224b and hangs between the side rails 224a, 224b, defining a curved surface (e.g., parabolic curvature). The reflective film 210 is held in tension by the side rails 224a, 224b (once attached to the slots 227), causing the edges of the reflective film 210 to be stretched apart and the center portion of the reflective film 210 to assume a curved shape, as noted above.

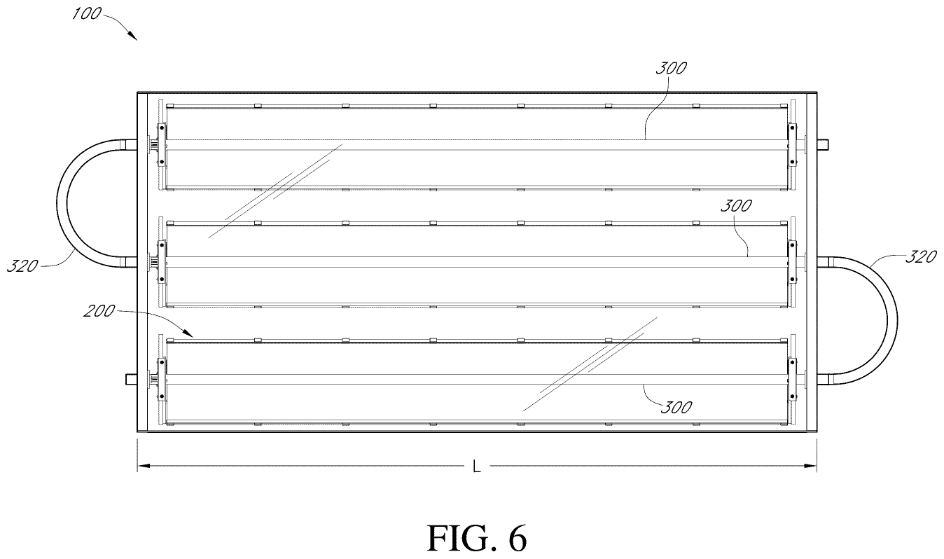

As shown in FIGS. 1-8, a tube or pipe 300 (a hollow tube or pipe) can extend through the center openings 232 in the pair of end plates 230 of the through concentrator 200 and extend along the length of the through concentrator 200 (e.g., extend along an axis between opposite sides of the housing 10). The tube or pipe 300 can be made of metal (e.g. steel) and define a path via which a fluid (e.g., water) can flow (e.g., a liquid such as water flows through the tube or pipe 300). The reflective film 210 can concentrate reflected sunlight on the tube or pipe 300 to heat the tube of pipe 300 and fluid flowing therein. Where the concentrator system 100 has multiple trough concentrators 200, the tube of pipe 300 of each of the trough concentrators 200 can be connected by connecting tubes 320 (via bushings 322 that extend in the openings 8a of the housing 10) to thereby provide a continuous path (for the multiple trough concentrators 200 of the concentrator system 100) along which the fluid flows, as shown in FIG. 6, allowing the fluid to receive heat from all the trough concentrators 200 in the concentrator system 100.

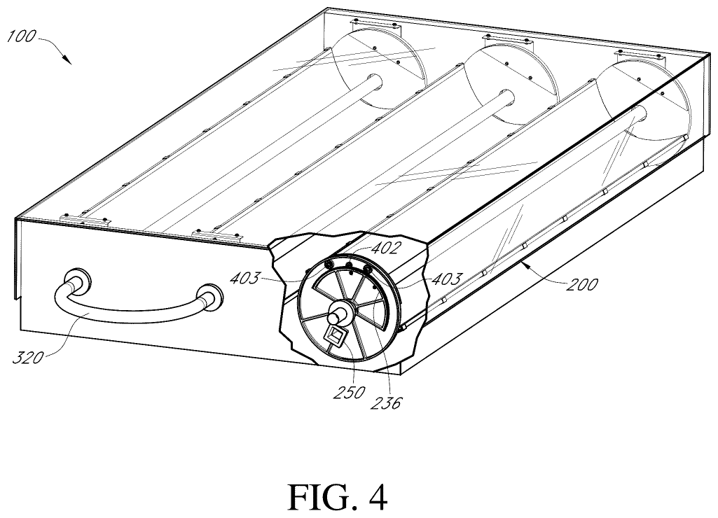

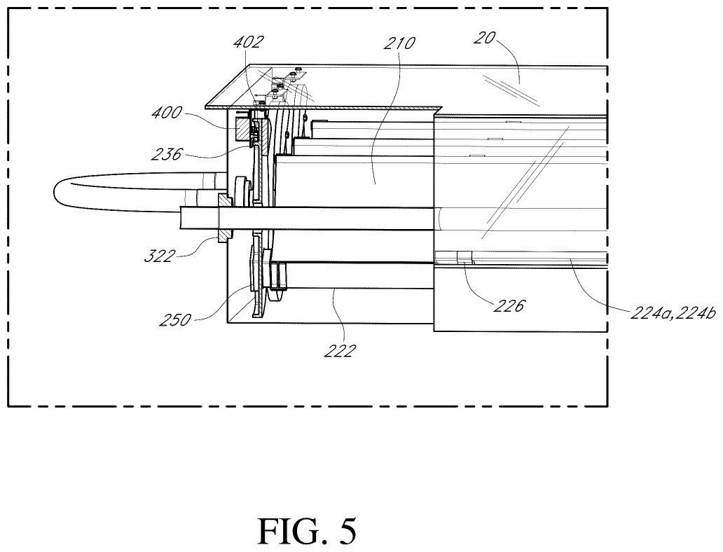

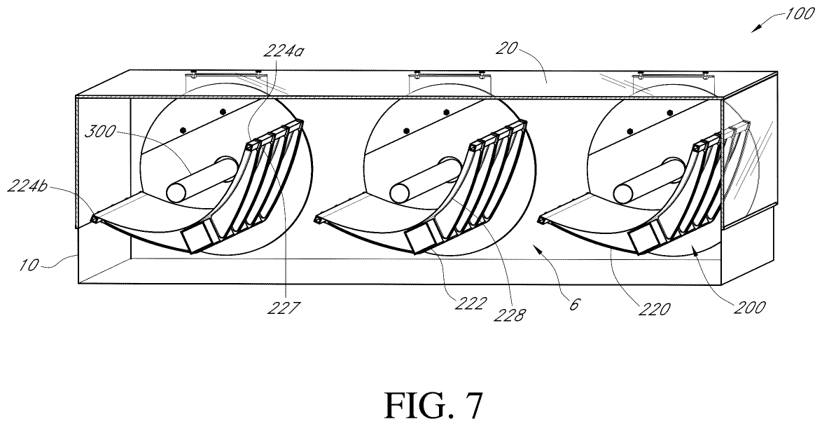

Each of the trough concentrators 200 can be rotated about the axis of the center openings 232 in the pair of end plates 230 to track the sun. With reference to FIGS. 4-5, one of the pair of end plates 230 of each trough concentrators 200 has a ring gear 236 that engages a gear 402 of an actuator 400 disposed in the housing 10 (e.g., between a wall 4a of the housing 10 and the end plate 230 with the ring gear 236) and one or more (e.g., two) bearings 403 that facilitate rotation the trough concentrator 200 about the axis of the center openings 232 (without contacting the tube or pipe 300). This advantageously avoids the use of a bearing about the tube or pipe 300, which can get very hot during use of the trough concentrator(s) 200. The actuator 400 is controlled by a tracking controller (not shown) of the trough concentrator 200. In operation, the actuator 400 rotates the gear 402, which rotates the end plate 230 via the ring gear 236, to adjust the orientation of the trough concentrator 200 to face the sun (e.g. via instructions the actuator 400 receives from the tracking controller). Since the end plates 230 are attached to the support frame 220, which is attached to the reflective film 210 (as described above), rotation of the end plate 230 via the ring gear 236 rotates the entire trough concentrator 200 and varies the orientation of the reflective film 210 relative to the sun. In one example, all trough concentrators 200 in the concentrator system 100 are controlled together (e.g., rotate in unison in the same direction and by the same amount), for example as shown in FIG. 7. For example, all trough concentrators 200 in the concentrator system 100 can be controlled by the same tracking controller. In another example, all trough concentrators 200 in the concentrator system 100 are controlled independently of each other and may have a different orientation relative to the sun. For example, each of the trough concentrators 200 in the concentrator system 100 can be controlled by separate tracking controllers.

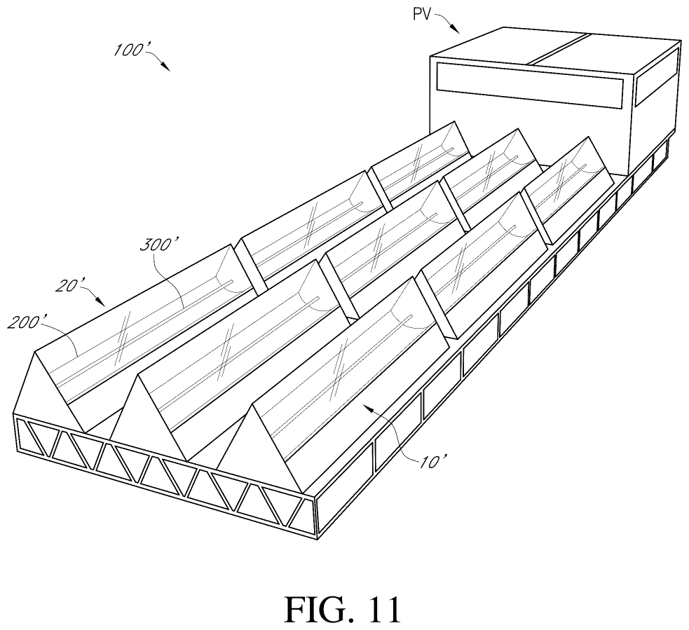

FIG. 11 shows a trough concentrator system 100′ (hereafter also referred to as “the concentrator system 100′”). The concentrator system 100′ has three trough concentrators 200′. However, the concentrator system 100′ can have any number (e.g. one, two, four, five, etc.) of trough concentrators 200′. The concentrator system 100′ can be affixed to the ground or other rigid surface. The concentrator system 100′ and trough concentrators 200′ in FIG. 11 may have any of the features of the concentrator system 100 and trough concentrator(s) 200 in FIGS. 1-10, and the concentrator system 100 and trough concentrator(s) 200 in FIGS. 1-10 may have any of the features of the concentrator system 100′ and trough concentrators 200′ in FIG. 11, except for the differences described with reference to FIG. 11.

The concentrator system 100′ differs from the concentrator system 100 in that the glass 20′ and housing 10′ form a triangular shape with the glass 20′ defining a portions of two sides of the triangular shape, and the third side of the triangular shape defined by the housing 10′, and in that only one trough concentrator 200′ being housed in each housing 10′ and glass 20′. The triangular shape of the glass 20′ and housing 10′ is advantageously sized to allowing the trough concentrator 200′ to rotate under the glass 20′. The fluid (e.g., water) heated in the tube or pipe 300′ can be directed, for example, to a turbine, heat engine, or thermal storage unit.

As discussed above the trough concentrator(s) 200, 200′ are advantageously shielded from wind by the glass 20, 20′ attached to the housing 10, 10′ while allowing sunlight to pass through the glass 20, 20′ to the reflective film(s) 210. Further, by shielding the trough concentrator(s) 200, 200′ with the glass 20, 20′, the electronics needed (e.g., actuator 400) to rotate the trough concentrator(s) 200, 200′ can be small, inexpensive components and require less energy to operate (e.g., due to not having to operate against a wind load on the trough concentrator(s) 200, 200′), which can be provided, for example, by one or more photovoltaic (PV) panels.

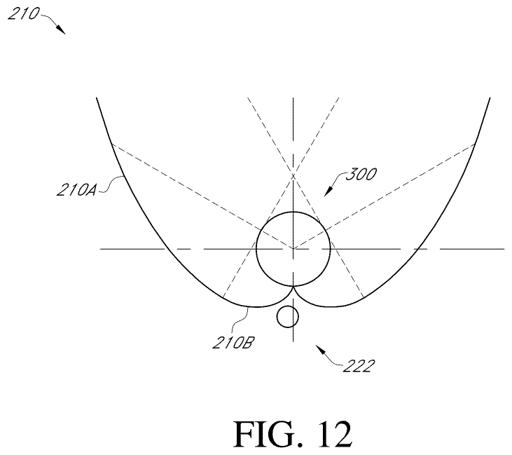

In one example, shown in FIG. 12, the reflective film 210 forms a non-parabolic shape. For example, the reflective film 210 can hang from side rails 224a, 224b attached to the end plates 230, and against a center beam 222 to define the non-parabolic shape that directs reflected sunlight onto the tube or pipe 300. In this example, the cross-beams 226 can be excluded. The reflective film 210 can have a parabolic section 210A and an involute section 210B.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of the stated amount. As another example, in certain embodiments, the terms “generally parallel” and “substantially parallel” refer to a value, amount, or characteristic that departs from exactly parallel by less than or equal to 15 degrees.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects and advantages of the present invention, to which various changes and modifications can be made without departing from the spirit and scope of the present invention. Moreover, the devices described herein need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still fall within the scope of the invention. Accordingly, it should be understood that various features and aspects of the disclosed embodiments can be combined with or substituted for one another in order to form varying modes of the discussed devices.

What is claimed is:

1. A solar power concentrator system, comprising:
a housing;
a glass coupled to the housing to define an enclosure therebetween; and
a trough concentrator rotatably disposed in the enclosure, comprising:
a pair of end plates,
a support frame extending between opposite ends of the housing and attached to the end plates,
a tube or pipe extending along a length of the support frame configured to allow a fluid to pass therethrough,, the tube or pipe extending along an axis between the opposite ends of the housing,
a reflective film having opposite edges attached to side rails of the support frame, the reflective film having a parabolic curved shape between the opposite edges and configured to reflect sunlight onto the tube or pipe, and
an actuator coupled to one of the end plates and operable to rotate the trough concentrator about the axis to vary an orientation of the reflective film,
wherein the glass shields the reflective film of the trough concentrator from wind.

2. The system of claim 1, wherein the reflective film is a mylar film.

3. The system of claim 1, wherein trough concentrator are multiple trough concentrators.

4. The system of claim 3, wherein the tube of the multiple trough concentrators defines a continuous path via which the fluid passes.

5. The system of claim 1, wherein the support frame includes a center beam coupled to the pair of end plates, a plurality of cross-beams coupled to the center beam, and a pair of side rails coupled to opposite ends of the plurality of cross-beams, the pair of side rails attached to opposite edges of the reflective film.

6. The system of claim 5, wherein each cross-beam has a curved surface configured to support the reflective film.

7. A solar power concentrator system, comprising:
a housing;
a glass coupled to the housing to define an enclosure therebetween; and
a trough concentrator rotatably disposed in the enclosure, comprising:
a support frame extending between opposite ends of the housing,
a tube or pipe extending along a length of the support frame configured to allow a fluid to pass therethrough, the tube or pipe extending along an axis between the opposite ends of the housing,
a reflective film having opposite edges attached to side rails of the support frame, the reflective film having a parabolic curved shape between the opposite edges and configured to reflect sunlight onto the tube or pipe, and
an actuator operable to rotate the trough concentrator about the axis to vary an orientation of the reflective film,
wherein the glass shields the reflective film of the trough concentrator from wind.

8. The system of claim 7, wherein the reflective film is a mylar film.

9. The system of claim 7, wherein trough concentrator are multiple trough concentrators.

10. The system of claim 9, wherein the tube of the multiple trough concentrators defines a continuous path via which the fluid passes.

11. The system of claim 7, wherein the support frame includes a center beam and a pair of side rails attached to opposite edges of the reflective film.

12. The system of claim 11, wherein the support frame includes a plurality of cross-beams coupled to the center beam, the pair of side rails coupled to opposite ends of the plurality of cross-beams.

13. The system of claim 12, wherein each cross-beam has a curved surface configured to support the reflective film.

14. A solar power concentrator system, comprising:
a housing;
a glass coupled to the housing to define an enclosure therebetween; and
a trough concentrator rotatably disposed in the enclosure, comprising:
a support frame extending between opposite ends of the housing,
a tube or pipe extending along a length of the support frame configured to allow a fluid to pass therethrough, the tube or pipe extending along an axis between the opposite ends of the housing,
a reflective film having opposite edges attached to side rails of the support frame, the reflective film having a curved shape between the opposite edges and configured to reflect sunlight onto the tube or pipe, and
an actuator operable to rotate the trough concentrator about the axis to vary an orientation of the reflective film,
wherein the glass shields the reflective film of the trough concentrator from wind.

15. The system of claim 14, wherein the reflective film is a mylar film.

16. The system of claim 14, wherein trough concentrator are multiple trough concentrators.

17. The system of claim 16, wherein the tube of the multiple trough concentrators defines a continuous path via which the fluid passes.

18. The system of claim 14, wherein the support frame includes a center beam and a pair of side rails attached to opposite edges of the reflective film.

19. The system of claim 18, wherein the support frame includes a plurality of cross-beams coupled to the center beam, the pair of side rails coupled to opposite ends of the plurality of cross-beams.

20. The system of claim 19, wherein each cross-beam has a curved surface configured to support the reflective film.
